(19) United States
(12) Patent Application Publication
(10) Pub. No.: US 2025/0257171 A1
(43) Pub. Date: Aug. 14, 2025

(54) BIODEGRADABLE COPOLYMER COMPOSITION

(71) Applicant: B4PLASTICS BV, Dilsen-Stokkem (BE)

(72) Inventors: Stefaan DE WILDEMAN, Maasmechelen (BE); Luciano MONSEGUE, Maastricht (NL)

(21) Appl. No.: 18/856,329

(22) PCT Filed: Apr. 14, 2023
(86) PCT No.: PCT/EP2023/059740

§ 371 Date: Oct. 11, 2024

(30) Foreign Application Priority Data
Apr. 15, 2022 (EP) 22168639.7

(51) Int. Cl. C08G 63/183; C08G 63/85; C08G 69/44

(52) U.S. Cl. CPC C08G 63/183; C08G 63/85; C08G 69/44; C08G 2230/00

(57) ABSTRACT

Disclosed herein are biodegradable copolymer compositions essentially consisting of a polyethylene terephthalate (PET) component and a polycondensation component chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof, wherein the molar ratio of PET to polycondensation component ranges between 1:4 to 4:1.

### FIELD OF THE INVENTION

The present invention relates to biodegradable copolymer compositions and methods for the manufacture thereof

### BACKGROUND

Plastics and rubbers are industrially mass-produced and at the same time are used widely in daily life and in industrial fields with their usage increasing greatly. These synthetic polymeric materials have been used for these various applications because of their characteristic properties, including low cost, ease of processing, and high ratios of mechanical strength to density. It is desirable that the products comprising these plastics and rubbers withstand the forces of nature and the wear from their designated use. Because most polymeric materials have been developed for improved mechanical properties and durability, they preserve the original shapes and properties even after the end of their service life. As a result, many of these types of materials and products do not naturally decompose, and they are considered to cause some environmental problems. The solution to these problems involves not only the simple recycling of plastics but also biodegradable polymeric materials, which can be degraded into small molecules by sunlight, water, or microorganisms in the earth form part of the solution. What is often overlooked, is that degradability is a good strategy for the many plastics and rubber applications that wear out: the microplastics that are formed diffuse in the environment and cannot be recycled anymore by normal industrial means. The controlled degradation of such microplastics becomes increasingly important and attractive to make the leap to a New Plastics Economy.

As a result, there exists a growing need for materials, products and methods related to plastic or rubber materials that can be biodegraded in a natural environment. Such materials, products and methods are described herein.

### SUMMARY

Accordingly, in a first aspect, the present invention provides a biodegradable copolymer composition comprising a polyethylene terephthalate (PET) component and a polycondensation component chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof, wherein the molar ratio of PET to polycondensation component ranges between 1:4 to 4:1.

In a particular embodiment the biodegradable copolymer composition as disclosed herein essentially consists of a polyethylene terephthalate (PET) component and a polycondensation component chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof, wherein the molar ratio of PET to polycondensation component ranges between 1:4 to 4:1.

In a particular embodiment the biodegradable copolymer composition as disclosed herein provides that:
the polycondensation component is a linear aliphatic diol or diamine chosen from 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,2-ethanediamine, 1,3-propanediamine, 1,4-butanediamine, 1,5-pentanediamine, 1,6-hexanediamine, 1,7-heptanediamine, 1,8-octanediamine, 1,9-nonanediamine, 1,10-decanediamine, 1,11-undecanediamine and/or 1,12-dodecanediamine;
the polycondensation component is a linear aliphatic dicarboxylic acid chosen from heptanedioic acid, octanedioic acid, nonanedioic acid and/or decanedioic acid;
the polycondensation component is a branched aliphatic diol or diamine chosen from alkylated or arylated 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,2-ethanediamine, 1,3-propanediamine, 1,4-butanediamine, 1,5-pentanediamine, 1,6-hexanediamine, 1,7-heptanediamine, 1,8-octanediamine, 1,9-nonanediamine and/or 1,10-decanediamine;
the polycondensation component is a branched aliphatic dicarboxylic acid chosen from alkylated malonic acid, alkylated succinic acid, alkylated pentanedioic acid, alkylated adipic acid, alkylated heptanedioic acid, alkylated octanedioic acid, alkylated nonanedioic acid, alkylated decanedioic acid, alkylated undecanedioic acid, alkylated dodecanedioic acid, alkylated tridecanedioic acid, alkylated hexadecanedioic, and/or dimer fatty diacids;
the polycondensation component is an aliphatic hydroxy acid chosen from 2-hydroxy-propanoic acid, 3-hydroxy-propanoic acid, 3-hydroxy-butyric acid, 4-hydroxy-butyric acid, 3-hydroxy-pentanoic acid, 4-hydroxy-pentanoic acid, and/or 5-hydroxy-pentanoic acid; and/or;
the polycondensation component is an aliphatic amino acid chosen from 2-amino-propanoic acid, 3-amino-propanoic acid, 3-amino-butyric acid, 4-amino-butyric acid, 4-amino-pentanoic acid, 5-amino-pentanoic acid, 6-amino-hexanoic acid, 9-amino-stearic acid, 9-aminomethyl-stearic acid, 10-amino-stearic acid, 10-aminomethyl-stearic acid, 11-amino-undecanoic acid, 12-amino-dodecanoic acid, and/or 12-amino-stearic acid.

In a particular embodiment the biodegradable copolymer composition as disclosed herein provides that the PET component is a PET component from PET post-consumer waste sources.

In a particular embodiment the biodegradable copolymer composition as disclosed herein provides that the molar ratio of PET to polycondensation component ranges between 1:3 to 3:1, more preferably between 1:2 to 2:1 and more preferably in a range of about 1:1.

In a further aspect the present invention relates to a method for preparing a biodegradable copolymer composition as disclosed herein, comprising the steps of:
(a) preparing a PET prepolymer;
(b) preparing a polycondensation prepolymer chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof;
(c) polycondensation of the PET prepolymer with the polycondensation prepolymer in a molar ratio of PET to polycondensation component ranges between 1:4 to 4:1.

In a particular embodiment the method as disclosed herein provides that step (a) occurs through esterification between terephthalic acid or dimethylterephthalate and ethylene glycol or through depolymerization of PET towards oligomeric PET prepolymers.

In a particular embodiment the method as disclosed herein provides that step (b) occurs through esterification.

In a particular embodiment the method as disclosed herein provides that step (c) comprises the steps of:
(c1) melting the PET prepolymer in a range of 10 to 30° C. above its softening point under inert conditions;
(c2) adding the polycondensation prepolymer to the molten PET component; and
(c3) reacting the PET component with the polycondensation prepolymer in the absence or the presence of a catalyst.

In a particular embodiment the method as disclosed herein provides that step (c3) occurs in the presence of a catalyst and wherein said catalyst is zinc acetate or titanium (IV) butoxide.

In a particular embodiment the method as disclosed herein provides that the molar ratio of PET to polycondensation component ranges between 1:3 to 3:1, more preferably between 1:2 to 2:1 and more preferably in a range of about 1:1.

In a further aspect the present invention relates to products comprising the biodegradable copolymer composition as disclosed herein. In particular said products are rubbery and soft-touch articles in the automotive industry, consumer goods, medical devices, building and construction and outdoor equipment.

### FIGURE

FIG. 1. Evolution of the respiration of the LM polymers in soil at 30° C., compared to starch; Average of 3 replicates; Horizontal lines indicate the level of easily biodegradable compounds in the polymers.

### DETAILED DESCRIPTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

All references cited in this description are hereby deemed to be incorporated in their entirety by way of reference.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, in particular +/−10% or less, more in particular +/−5% or less, even more in particular +/−1% or less, and still more in particular +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “weight percent”, “% wt” or “weight %”, here and throughout the description unless otherwise defined, refers to the relative weight of the respective component based on the overall weight of the formulation.

In view of the high need for plastic or rubber materials that can be biodegraded in a natural environment the present inventors have found that upon combining a polyethylene terephthalate (PET) component and a specific polycondensation component in particular ranges a biodegradable copolymer composition was obtained having a typical elastomeric/rubbery behavior. Depending on the type of polycondensation component used certain characteristics such as softness can be tweaked even further.

Accordingly, in a first aspect, the present invention is related to a biodegradable copolymer composition comprising a polyethylene terephthalate (PET) component and a polycondensation component chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof, wherein the molar ratio of PET to polycondensation component ranges between 1:4 to 4:1.

In a particular embodiment the biodegradable copolymer composition as disclosed herein essentially consists of a polyethylene terephthalate (PET) component and a polycondensation component chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof, wherein the molar ratio of PET to polycondensation component ranges between 1:4 to 4:1.

As used herein, the terms “biodegradable composition” and like terms refer to a material/composition that is biodegradable. The biodegradable composition typically refers to a (co)polymer which has nearly the same physical properties as general-purpose plastics in uses as a material, however, after wasted, those are fast decomposed and changed to valuable products by natural conditions such as microorganisms which are mostly bacteria and fungi, temperature, moisture, and light under natural circumstances such as active sludge, soils, composts, and water, which is finally decomposed until carbon dioxide and water. The degree of biodegradation can generally be determined using the biodegradation rate which refers to the time for a material to biodegrade to a specific degree. For example, a material that biodegrades 30% in 20 days has a higher biodegradation rate than a material that biodegrades 10% in 20 days.

As used herein the term “copolymer composition” refers to a polymeric composition wherein the polymer is a copolymer comprising two species of monomer obtained by copolymerization. Further, as used herein “plastic article” refers to a copolymer composition processed into a film, sheet, fiber, foam, molded article, nonwoven fabric, elastomer or adhesive. As used herein the copolymer as referred to herein provides in a polyethylene terephthalate (PET) component and a polycondensation component.

In a particular embodiment the copolymer is a linear copolymer such as an alternating copolymer, random copolymer, statistical copolymers, or block or segmented copolymer, or a branched copolymer such as a graft copolymer, star copolymer of a branched copolymer with a different architecture.

In particular the polycondensation component is chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof.

More in particular the polycondensation component is a linear aliphatic diol or diamine with from 3 to 12 carbon atoms, preferably 3, 4, 5, 6, 7, 8, 9, 10, 11 or 12 carbon atoms. As referred to herein, the term “aliphatic” refers to organic chemical compounds containing carbon and hydrogen joined together in straight chains (linear), branched chains, or non-aromatic rings. As referred to herein “aliphatic diol” refers to aliphatic compounds containing two hydroxyl (—OH) groups. As referred to herein “aliphatic diamine” refers to aliphatic compounds containing two amino groups.

More in particular the polycondensation component is a linear aliphatic dicarboxylic acid with from 7 to 10 carbon atoms, preferably 7, 8, 9 or 10 carbon atoms. As referred to herein “aliphatic dicarboxylic acid” refers to aliphatic compounds containing two carboxyl (—COOH) groups.

More in particular the polycondensation component is a branched aliphatic diol or diamine with from 3 to 12 carbon atoms, preferably 3, 4, 5, 6, 7, 8, 9, 10, 11 or 12 carbon atoms, and/or acetylated modifications thereof, the acetylated modifications preferably being chosen from acetylated polyols such as sorbitol.

More in particular the polycondensation component is a branched aliphatic dicarboxylic acid with from 3 to 36 carbon atoms, preferably 3, 4, 5, 6, 7, 8, 9, 10, 11, 12, 13, 14, 15, 16, 17, 18, 19, 20, 21, 22, 23, 24, 25, 26, 27, 28, 29, 30,31, or 32 carbon atoms, and/or acetylated modifications thereof, the acetylated modifications preferably being chosen from acetylated dicarboxylates such as tartaric acid and galactaric acid.

More in particular the polycondensation component is an aliphatic hydroxy acid with from 2 to 5 carbon atoms, preferably 2, 3, 4 or 5 carbon atoms, and/or acetylated modifications thereof. As referred to herein “aliphatic hydroxy acid” refers to a hydroxy acid containing an aliphatic side chain functional group.

More in particular the polycondensation component is an aliphatic amino acid with from 2 to 20 carbon atoms, preferably 3, 4, 5, 6, 7, 8, 9, 10, 11, 12, 13, 14, 15, 16, 17, 18, 19 or 20 carbon atoms, and/or acetylated modifications thereof, the acetylated modifications preferably being chosen from acetylated amino acids such as dihydroxy-lysine. As referred to herein “aliphatic amino acid” refers to an aliphatic amino acid containing a side chain functional group.

In a particular embodiment the molar ratio of PET to polycondensation component ranges between 1:4 to 4:1, more in particular between 1:3 and 3:1, more in particular between 1:2 and 2:1 and more in particular a molar ratio of PET to polycondensation component of about 1:1.

In a further particular embodiment the copolymer further comprises amide hydrogen bonding sites.

In a particular embodiment the biodegradable copolymer composition as disclosed herein provides that the polycondensation component is a linear aliphatic diol or diamine chosen from 1,5-pentanediol, 1,6-hexanediol, 1,7-heptanediol, 1,8-octanediol, 1,9-nonanediol, 1,10-decanediol, 1,5-pentanediamine, 1,6-hexanediamine, 1,7-heptanediamine, 1,8-octanediamine, 1,9-nonanediamine and/or 1,10-decanediamine. In a particular embodiment the biodegradable copolymer composition as disclosed herein essentially consists of a polyethylene terephthalate (PET) component and a polycondensation component wherein said polycondensation component is 1,5-pentanediol and/or 1,6-hexanediol.

In a particular embodiment the biodegradable copolymer composition as disclosed herein provides that the polycondensation component is a linear aliphatic dicarboxylic acid chosen from heptanedioic acid, octanedioic acid, nonanedioic acid, and/or decanedioic acid. In a particular embodiment the biodegradable copolymer composition as disclosed herein essentially consists of a polyethylene terephthalate (PET) component and a polycondensation component wherein said polycondensation component is nonanedioic acid, and/or decanedioic acid.

In a particular embodiment the biodegradable copolymer composition as disclosed herein provides that the polycondensation component is a branched aliphatic diol or diamine chosen from alkylated or arylated 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,5-pentanediamine, 1,6-hexanediamine, 1,7-heptanediamine, 1,8-octanediamine, 1,9-nonanediamine and/or 1,10-decanediamine. In a particular embodiment the biodegradable copolymer composition as disclosed herein essentially consists of a polyethylene terephthalate (PET) component and a polycondensation component wherein said polycondensation component is alkylated or arylated preferably 2-methyl-1,4-butanediol, 3-methyl-1,5-pentanediol, 1-phenylethane-1,2-diol and/or 2-methyl-1,5-pentanediamine.

In a particular embodiment the biodegradable copolymer composition as disclosed herein provides that the polycondensation component is a branched aliphatic dicarboxylic acid chosen from alkylated malonic acid, alkylated succinic acid, alkylated pentanedioic acid, alkylated adipic acid, alkylated heptanedioic acid, alkylated octanedioic acid, alkylated nonanedioic acid, alkylated decanedioic acid, alkylated undecanedioic acid, alkylated dodecanedioic acid, alkylated tridecanedioic acid, alkylated hexadecanedioic, and/or dimer fatty diacids. As referred to herein, the term “dimer fatty diacid” (also referred to as dimer fatty acid is well known in the art, and refers to the dimerisation products of mono-or polyunsaturated fatty acids and/or esters thereof. In a particular embodiment the biodegradable copolymer composition as disclosed herein essentially consists of a polyethylene terephthalate (PET) component and a polycondensation component wherein said polycondensation component is alkylated or arylated succinic acid such as 2-methyl-succinate.

In a particular embodiment the biodegradable copolymer composition as disclosed herein provides that the polycondensation component is an aliphatic hydroxy acid chosen from 2-hydroxy-propanoic acid, 3-hydroxy-propanoic acid, 3-hydroxy-butyric acid, 4-hydroxy-butyric acid, 3-hydroxy-pentanoic acid, 4-hydroxy-pentanoic acid, and/or 5-hydroxy-pentanoic acid.

In a particular embodiment the biodegradable copolymer composition as disclosed herein provides that the polycondensation component is an aliphatic amino acid chosen from 2-amino-propanoic acid, 3-amino-propanoic acid, 3-amino-butyric acid, 4-amino-butyric acid, 4-amino-pentanoic acid, 5-amino-pentanoic acid, 6-amino-hexanoic acid, 9-amino-stearic acid, 9-aminomethyl-stearic acid, 10-amino-stearic acid, 10-aminomethyl-stearic acid, 11-amino-undecanoic acid, 12-amino-dodecanoic acid, and/or 12-amino-stearic acid.

In a particular embodiment the biodegradable copolymer composition as disclosed herein provides that the PET component is derived from PET waste such as PET post-consumer waste. During PET recycling into the materials of the current invention, PET waste is washed, crushed, dried and further recycled and eventually chain elongated using commonly known recycling and chain elongation techniques.

In a particular embodiment the biodegradable copolymer composition as disclosed herein is characterized by having a molar ratio of PET to polycondensation component ranges between 1:3 to 3:1, more preferably between 1:2 to 2:1 and more preferably in a range of about 1:1.

In a particular embodiment the biodegradable copolymer composition as disclosed herein provides that said polymers are characterized by having a Mw of more than 10 kDa, more preferably more than 20 kDa and most preferably more than 30 kDa.

In a further aspect, disclosed herein is a method for preparing a biodegradable copolymer composition as disclosed herein, comprising the steps of:
(a) preparing a PET prepolymer;
(b) preparing a polycondensation prepolymer chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof;
(c) polycondensation of the PET prepolymer with the polycondensation prepolymer in a molar ratio of PET to polycondensation component ranges between 1:4 to 4:1.

In a particular embodiment the copolymer is a linear copolymer such as an alternating copolymer, random copolymer, statistical copolymers, or block or segmented copolymer, or a branched copolymer such as a graft copolymer, star copolymer of a branched copolymer with a different architecture.

In particular the polycondensation component is chosen from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms and/or acetylated modifications thereof.

In a particular embodiment the method as disclosed herein provides that step (a) occurs through esterification between terephthalic acid or dimethylterephthalate and ethylene glycol or through depolymerization of PET towards oligomeric PET prepolymers.

In a particular embodiment the method as disclosed herein provides that step (b) occurs through polycondensation. In particular, the polycondensation polymers achieve a chain length that allows entangled structures. More in particular the polymers are characterized by having a Mw of more than 10 kDa, more preferably more than 20 kDa and most preferably more than 30 kDa.

In a particular embodiment the method as disclosed herein provides that step (c) comprises the steps of:
(c1) melting the PET prepolymer in a range of 10 to 30° C. above its softening point under inert conditions;
(c2) adding the polycondensation prepolymer to the molten PET component; and
(c3) reacting the PET component with the polycondensation prepolymer in the absence or the presence of a catalyst.

In particular step (c1) is conducted at a temperature between 230° C. and 260° C. under N₂ atmosphere, more in particular a temperature of about 245° C.

In a particular embodiment the method as disclosed herein provides that wherein step (c3) occurs in the presence of a catalyst and wherein said catalyst is zinc acetate or titanium (IV) butoxide.

In a particular embodiment the method as disclosed herein provides that wherein step (c3) occurs in the presence of a catalyst and wherein said catalyst is Ti(BuO)₄. More in particular the step (c3) occurs at a temperature between 220° C. and 250° C. for a period of 3 to 8 hours, more in particular a temperature of about 235° C. for a period of 3 to 8 hours.

In a particular embodiment the method as disclosed herein provides that the molar ratio of PET to polycondensation component ranges between 1:3 to 3:1, more preferably between 1:2 to 2:1 and more preferably in a range of about 1:1.

In a further aspect the present invention relates to products comprising the biodegradable copolymer composition as disclosed herein. In particular said products are rubbery and soft-touch articles in the automotive industry (hosing under the hood, buttons, dashboard panels), consumer goods (drills, shaving devices, kitchen tools, clock wristbands), medical devices, building and construction (window liners, insulation panels) and outdoor equipment (shock absorbers, shoe soles, buttons and strips on backpacks).

### EXAMPLES

### Example 1

A biodegradable copolymer composition (LM092) according to the invention was manufactured by preparing a poly(decylene methylsuccinate) prepolymer by charging 2-methyl succinic acid (0.66 mol) and 1,10-decanediol (0.69 mol) into a reactor, heating the mixture to 135° C. under mechanical agitation and N₂ atmosphere and raising the temperature to 200-225° C. gradually for esterification with continuous water removal for 3 h (until no more water is removed). A PET prepolymer was prepared by charging terephthalic acid (1 mol) and ethylene glycol (1.3 mol) into a reactor and carried out esterification at 190° C. at 5 MPa pressure during 3-4 h.

The prepared prepolymers were polycondensated towards copolyesters by charging the PET prepolymer into a flask and melting it at 245° C. under N₂ flow and agitation, adding the polycondensate prepolymer to the flask, after 10 minutes adding a Ti(BuO)₄ catalyst and reacting the prepared mixture at 235° C. under 0.5 mmHg vacuum for 3-8 h.

Another biodegradable copolymer composition (LM086) according to the invention was manufactured by preparing a poly (decylene methylsuccinate) prepolymer by charging succinic acid (0.66 mol) and 1,10-decanediol (0.69 mol) into a reactor, heating the mixture to 135° C. under mechanical agitation and N₂ atmosphere and raising the temperature to 200-225° C. gradually for esterification with continuous water removal for 3 h (until no more water is removed). A PET prepolymer was prepared by charging terephthalic acid (1 mol) and ethylene glycol (1.3 mol) into a reactor and carried out esterification at 190° C. at 5 MPa pressure during 3-4 h.

The prepared prepolymers were polycondensated towards copolyesters by charging the PET prepolymer into a flask and melting it at 245° C. under N₂ flow and agitation, adding the polycondensate prepolymer to the flask, after 10 minutes adding a Ti(BuO)₄ catalyst and reacting the prepared mixture at 235° C. under 0.5 mmHg vacuum for 3-8 h.

Table 1 provides the characteristics of the prepared copolymers.

TABLE 1

| Sample | Melting point (° C.) | Glass transition temperature (° C.) |
|---|---|---|
| LM086 | 195 | −30 |
| LM092 | 90 | −30 |

The biodegradation of the LM086 and LM092 compositions was measured using the ASTMD5988-18 test method for biodegradation of plastics in soil conditions.

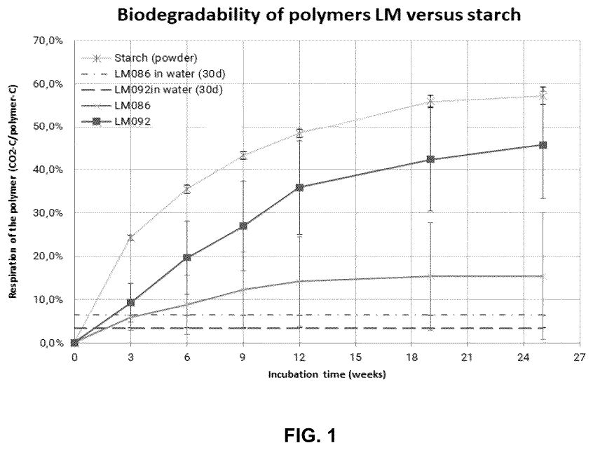

Polymer LM086 was on average biodegraded for 15% (range 10-20%) in 19 weeks, after which biodegradation seemed to stop. Polymer LM092 was degraded on average for 46% (range between 38% and 56%) in 6 months' time and degradation was proceeding. This average biodegradability of 46% is close to the biodegradability of starch (˜57%). In FIG. 1, it can be seen that the biodegradation of LM092 was in replicate 1 very similar to the biodegradation of starch. The soil respiration trial showed that polymer LM092 is highly biodegradable, with a biodegradability close to the biodegradability of starch under the same conditions.

### Example 2

A biodegradable copolymer composition according to the invention was manufactured by heating PET and poly (butylene succinate-co-butylene adipate) prepolymers according to the polycondensation method in example 1.

Sample A1 and A2 are copolymers which have been reacted from 2:3 prepolymers of PET: PBSA for respectively 1 h and 1.65 h at 280-290° C. Sample B1 and B2 are copolymers which have been reacted from 1:1 prepolymers of PET: PBSA for respectively Oh and 1.5 h at 280-290° C.

Table 2 provides the characteristics of the prepared copolymers.

TABLE 2

| | Melting point | Shore | Tensile | Tensile strain |
|---|---|---|---|---|
| Sample | (° C.) | hardness A | strength (MPa) | at break (%) |
| A1 | 168 | 89 | 5.72 | 75 |
| A2 | 128 | 86 | 3.92 | 65 |
| B1 | 230 | 96.5 | 20.1 | 153 |
| B2 | 159 | 90 | 5.98 | 110 |

From the shore hardness A parameter it can be concluded that the prepared copolymer compositions have an outspoken elastomeric thermoplastic behavior.

### Example 3

A biodegradable copolymer composition (LMP03) according to the invention is manufactured by preparing a poly (neopentyl sebacate) prepolymer by charging sebacic acid (0.66 mol) and neopentyl glycol (0.69 mol) into a reactor, heating the mixture to 135° C. under mechanical agitation and N₂ atmosphere and raising the temperature to 200-225° C. gradually for esterification with continuous water removal for 3 h (until no more water is removed). A PET prepolymer is prepared according to example 1.

The prepared prepolymers are polycondensated towards copolyesters by charging the PET prepolymer into a flask and melting it at 245° C. under N₂ flow and agitation, adding the polycondensate prepolymer to the flask, after 10 minutes adding a Ti(BuO)₄ catalyst and reacting the prepared mixture at 235° C. under 0.5 mmHg vacuum for 3-8 h.

### Example 4

A biodegradable copolymer composition (LMP04) according to the invention is manufactured by preparing a poly (6-hydroxy-hexanoate) prepolymer by charging 1 mol 6-hexanolactone and 0.1 mol decylalcohol into a reactor, heating the mixture to 150° C. under mechanical agitation and N₂ atmosphere and raising the temperature to 200° C. gradually for 30 minutes. A PET prepolymer is prepared according to example 1.

The prepared prepolymers are equimolarly polycondensated towards copolyesters by charging the PET prepolymer into a flask and melting it at 245° C. under N₂ flow and agitation, adding the poly (6-hydroxy-hexanoate) prepolymer to the flask, adding 20 mol % succinic anhydride, after 10 minutes adding 250 ppm of a Ti(BuO)₄ catalyst and reacting the prepared mixture at 235° C. under 0.5 mmHg vacuum for 3-8 h.

### Example 5

A biodegradable copolymer composition (LMP05) according to the invention is manufactured by preparing a poly (6-amino-hexanoate) prepolymer by charging 1.0 mol 6-amino-hexanoic acid and 0.05 mol of acetic acid into a reactor, heating the mixture to 180° C. under mechanical agitation and N₂ atmosphere and raising the temperature to 260° C. gradually for amidation with continuous water removal for 8 h. A PET prepolymer is prepared according to example 1.

The prepared prepolymers are equimolariy polycondensated by charging the PET prepolymer into a flask and melting it at 245° C. under N₂ flow and agitation, adding the poly (6-amino-hexanoate) prepolymer to the flask, adding 20 mol % adipic anhydride, after 10 minutes adding 250 ppm of a Ti(BuO)₄ catalyst and reacting the prepared mixture at 235° C. under 0.5 mmHg vacuum for 3-8 h.

What is claimed is:

1. A biodegradable copolymer composition comprising of a polyethylene terephthalate (PET) component and a polycondensation component selected from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms, and/or at least one or more acetylated modifications thereof, wherein the molar ratio of PET to polycondensation component ranges from about 1:4 to 4:1.

2. The biodegradable copolymer composition according to claim 1, wherein the polycondensation component is a linear aliphatic diol or diamine selected from 1,5-pentanediol, 1,6-hexanediol, 1,7-heptanediol, 1,8-octanediol, 1,9-nonanediol, 1,10-decanediol, 1,5-pentanediamine, 1,6-hexanediamine, 1,7-heptanediamine, 1,8-octanediamine, 1,9-nonanediamine, and/or 1,10-decanediamine.

3. The biodegradable copolymer composition according to claim 1, wherein the polycondensation component is a linear aliphatic dicarboxylic acid selected from heptanedioic acid, octanedioic acid, nonanedioic acid, and/or decanedioic acid.

4. The biodegradable copolymer composition according to claim 1, wherein the polycondensation component is a branched aliphatic diol or diamine selected from alkylated or arylated 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,5-pentanediamine, 1,6-hexanediamine, 1,7-heptanediamine, 1,8-octanediamine, 1,9-nonanediamine, and/or 1,10-decanediamine.

5. The biodegradable copolymer composition according to claim 1, wherein the polycondensation component is a branched aliphatic dicarboxylic acid selected from alkylated malonic acid, alkylated succinic acid, alkylated pentanedioic acid, alkylated adipic acid, alkylated heptanedioic acid, alkylated octanedioic acid, alkylated nonanedioic acid, alkylated decanedioic acid, alkylated undecanedioic acid, alkylated dodecanedioic acid, alkylated tridecanedioic acid, alkylated hexadecanedioic, and/or dimer fatty diacids.

6. The biodegradable copolymer composition according to claim 1, wherein the polycondensation component is an aliphatic hydroxy acid selected from 2-hydroxy-propanoic acid, 3-hydroxy-propanoic acid, 3-hydroxy-butyric acid, 4-hydroxy-butyric acid, 3-hydroxy-pentanoic acid, 4-hydroxy-pentanoic acid, and/or 5-hydroxy-pentanoic acid.

7. The biodegradable copolymer composition according to claim 1, wherein the polycondensation component is an aliphatic amino acid selected from 2-amino-propanoic acid, 3-amino-propanoic acid, 3-amino-butyric acid, 4-amino-butyric acid, 4-amino-pentanoic acid, 5-amino-pentanoic acid, 6-amino-hexanoic acid, 9-amino-stearic acid, 9-aminomethyl-stearic acid, 10-amino-stearic acid, 10-aminomethyl-stearic acid, 11-amino-undecanoic acid, 12-amino-dodecanoic acid, and/or 12-amino-stearic acid.

8. The biodegradable copolymer composition according to claim 1, wherein the PET component is a PET component from PET post-consumer waste sources.

9. A method for preparing a biodegradable copolymer composition according claim 1, comprising the steps of:
(a) preparing a PET prepolymer;
(b) preparing a polycondensation prepolymer selected from a linear aliphatic diol or diamine with from 3 to 12 carbon atoms, a linear aliphatic dicarboxylic acid with from 7 to 10 carbon atoms, a branched aliphatic diol or diamine with from 3 to 12 carbon atoms, a branched aliphatic dicarboxylic acid with from 3 to 32 carbon atoms, an aliphatic hydroxy acid with from 2 to 5 carbon atoms, an aliphatic amino acid with from 2 to 20 carbon atoms, and/or at least one or more acetylated modifications thereof; and
(c) performing polycondensation of the PET prepolymer with the polycondensation prepolymer in a molar ratio of PET to polycondensation component ranges between 1:4 to 4:1.

10. The method according to claim 9, wherein step (a) occurs through esterification between terephthalic acid or dimethylterephthalate, and ethylene glycol, or through depolymerization of PET towards oligomeric PET prepolymers.

11. The method according to claim 9, wherein step (b) occurs through esterification.

12. The method according to claim 9, wherein step (c) comprises the steps of:
(c1) melting the PET prepolymer in a range of 10 to 30° C. above its softening point under inert conditions;
(c2) adding the polycondensation prepolymer to the molten PET component; and
(c3) reacting the PET component with the polycondensation prepolymer in the absence or the presence of a catalyst.

13. The method according to claim 12, wherein step (c3) occurs in the presence of a catalyst, and wherein said catalyst is zinc acetate or titanium (IV) butoxide.

14. The biodegradable copolymer composition according claim 1, wherein the molar ratio of PET to polycondensation component ranges between 1:3 to 3:1, or ranges between 1:2 to 2:1, or is about and more preferably in a range of about 1:1.

15. A product comprising the biodegradable copolymer composition according to claim 1, wherein said product is rubbery and soft-touch articles in the automotive industry, consumer goods, medical devices, building and construction and outdoor equipment.

16. The method according to claim 9, wherein the molar ratio of PET to polycondensation component ranges between 1:3 to 3:1, or ranges between 1:2 to 2:1, or is about 1:1.

17. A product comprising the biodegradable copolymer composition according to claim 14, wherein said product is rubbery and soft-touch articles in the automotive industry, consumer goods, medical devices, building and construction and outdoor equipment.
